(19) United States
(12) Patent Application Publication
(10) Pub. No.: US 2026/0320346 A1
(43) Pub. Date: Oct. 15, 2026

(54) FEDERATED GRAPH NEURAL NETWORKS WITH DIFFUSION PRIORS FOR SCALABLE AND SECURE INTERNET OF THINGS (IOT) SYSTEMS

(71) Applicant: Dell Products L.P., Round Rock, TX (US)

(72) Inventors: Shashank Kapoor, Agra (IN); Kailash Talreja, Mumbai (IN); Saurabh Jha, Leander, TX (US)

(21) Appl. No.: 19/178,207

(22) Filed: Apr. 14, 2025

(51) Int. Cl. G06N 3/04

(52) U.S. Cl. CPC G06N 3/04

(57) ABSTRACT

A method for generating a global graph neural network (GNN) model, the method includes collecting data from a node cluster, preparing the data for the global GNN model, where the preparing includes preprocessing the data to obtain preprocessed data, extracting node information from the preprocessed data to obtain nodes, edges, and node attributes, determining edge weights based on the edges, assigning each node to a subgraph based on the edge weights and the node attributes, and calculating, based on the assigning, diffusion scores for each node of the nodes based on the edge weights connecting the nodes and the node attributes associated with the nodes within respective subgraphs. Further, the method includes generating the global GNN model using the edge weights, the diffusion scores, and node attributes from each subgraph.

### BACKGROUND

The emergence of Internet of Things (IoT) systems has heightened the demand for scalable, efficient, and secure architectures tailored to processing graph-structured data. Existing computational models often exhibit limitations in effectively representing the complex interdependencies and relational structures intrinsic to such data.

### BRIEF DESCRIPTION OF DRAWINGS

Certain embodiments of the disclosure will now be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a diagram of a global graph in accordance with one or more embodiments.

FIG. 3 shows a flowchart of a method for generating data insights using a global graph neural network (GNN) model in accordance with one or more embodiments.

FIG. 4 shows a flowchart of a method for generating a global GNN model in accordance with one or more embodiments.

FIG. 5 shows a flowchart of a method for generating a global GNN model in accordance with one or more embodiments.

FIG. 6 shows a flowchart of a method for monitoring a node cluster in accordance with one or more embodiments.

FIG. 7 shows a diagram of a computing system in accordance with one or more embodiments.

### DETAILED DESCRIPTION

The rise of Internet of Things (IoT) systems has introduced unprecedented levels of connectivity, enabling billions of devices to communicate and collaborate. These systems are characterized by dynamic topologies, heterogeneous devices, and vast amounts of graph-structured data. Further, IoT systems often include devices that have limited networking and computing resources, thereby enhancing the need for resource-efficient solutions. However, the rapid growth of IoT systems has intensified the need for scalable, efficient, and secure frameworks capable of handling graph-structured data. Early advancements, such as Generative Adversarial Networks (GANs), revolutionized data generation but failed to address non-Euclidean graph structures inherent to IoT systems. Additionally, the introduction of Graph Convolutional Networks (GCNs) significantly advanced graph-based learning but lacked scalability in large-scale dynamic environments.

Prior implementations have attempted to extend these ideas to dynamic networks, focusing on anomaly detection. However, this centralized approach fails to account for IoT systems that require distributed and privacy-preserving solutions. Moreover, previous attempts have failed to incorporate efficient graph partitioning or relational learning for heterogeneous IoT environments. Further, current models struggle to accurately capture the inherent relationships and dependencies within graph structured data. The lack of integration of relational insights reduces learning efficiency and generalization across heterogeneous IoT environments. These challenges highlight the necessity of a solution that integrates dynamic graph partitioning and diffusion priors to enable scalable, efficient, and adaptive learning in IoT systems.

This proposed solution addresses these challenges using a Federated Graph Neural Network (FedGNN) framework augmented with diffusion priors. The disclosure utilizes graph theory and machine learning to enable efficient learning and decision-making in IoT environments. By decomposing complex networks into manageable subgraph structures and processing them using federated learning, the framework ensures scalability and privacy-preserving collaboration among devices. The core components of the system include dynamic graph partitioning, diffusion priors, sparse encoders, temporal consistency mechanisms, and privacy-preserving protocols, each of which is discussed below.

The dynamic partitioning includes dividing large, dynamic IoT networks into smaller subgraphs. Each subgraph contains a subset of nodes and edges based on criteria like proximity or connectivity, where each node represents a device, and the edges represent a connection or relationship between devices. The subgraphs adapt dynamically to changes, such as new nodes being added or existing nodes being removed. By utilizing subgraphs, the subgraphs are computationally manageable and can quickly and efficiently adapt to changes in network topology enabling scalable and efficient federated learning because only the subgraph and the subgraphs effect on a global GNN model need to be updated rather than the entirety of the global GNN model.

Further, the diffusion priors are usable to capture inherent relationships in graph data. These relationships reveal how information or influence propagates through the subgraphs, thereby improving learning efficiency and model accuracy.

The sparse encoders are used to optimize the communication of global GNN model parameters across IoT devices. They facilitate low-bandwidth communication between IoT devices, ensuring seamless integration with resource-constrained environments.

Finally, the temporal consistency mechanisms monitor, update, and recalibrate a global GNN model to handle dynamic conditions such as node failures, new device additions, or changing network patterns, thereby maintaining robustness in the face of real-time network changes and dynamic graph updates.

By combining these components, the disclosure enables IoT systems to operate efficiently and securely, even in highly dynamic and resource-constrained environments. This framework provides a transformative approach to addressing the limitations of current IoT systems.

Specific embodiments will now be described with reference to the accompanying figures.

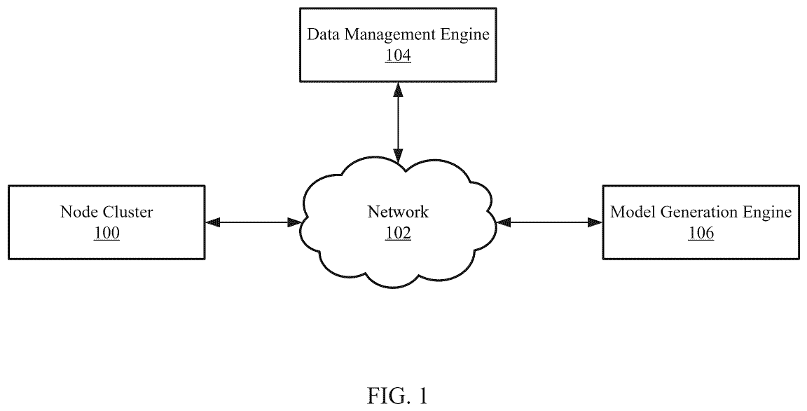

FIG. 1 shows a system in accordance with one or more embodiments. The system may include a node cluster (100), a network (102), a data management engine (104), and a model generation engine (106). The system may include additional, fewer, and/or different components without departing from the scope of the embodiments disclosed herein. Each component may be operably/operatively connected to any of the other components via any combination of wired and/or wireless connections. Each of these system components is described below.

In one or more embodiments, the node cluster (100), the network (102), the data management engine (104), and the model generation engine (106) may be operatively connected to one another through the network (102) (e.g., a local area network (LAN), a wide area network (WAN) such as the Internet, a mobile network, any other network type, or a combination thereof). Further, the network (102) may encompass various interconnected, network-enabled subcomponents (or systems) (e.g., switches, routers, gateways, etc.) that may facilitate communications between the aforementioned components. Moreover, the node cluster (100), the network (102), the data management engine (104), and the model generation engine (106) may communicate with one another using any combination of wired and/or wireless communication protocols.

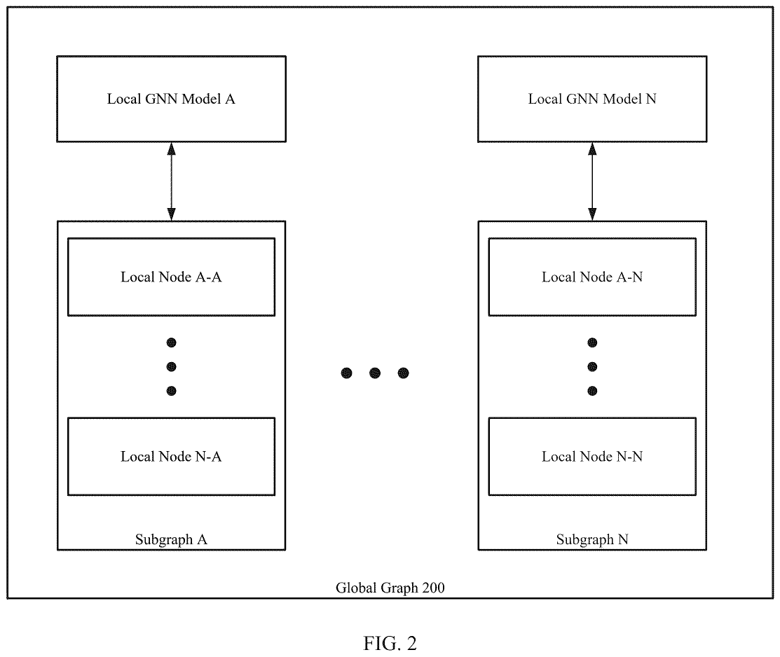

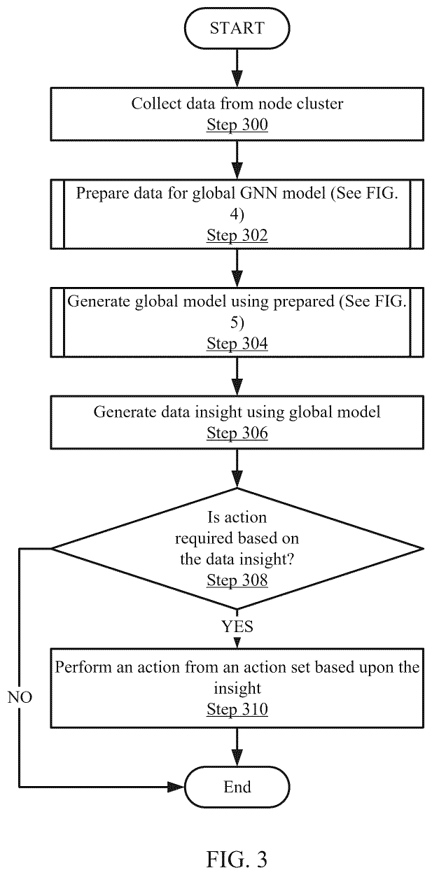

In one or more embodiments, node cluster (100) is a group of interconnected IoT devices (e.g., sensors, actuators, etc.) that work together to monitor or control a localized environment. In one or more embodiments, each IoT device in the node cluster (100) is represented as a node, and the communication and data exchange between the nodes is represented as edges. In one or more embodiments, the node cluster (100) can be represented as a global graph (e.g., 200 in FIG. 2) (i.e., graph-structured data), as described below in FIG. 2. In one or more embodiments, the global graph (e.g., 200 in FIG. 2) captures how the nodes interact and communicate within the node structure as described below in FIG. 2. Further, the node cluster (100) may include functionality to perform at least a portion of the methods shown in FIGS. 3-6. One of ordinary skill in the art will appreciate that the node cluster (100) may perform other functionalities without departing from the scope of the embodiments disclosed herein.

In one or more embodiments, the data management engine (104) includes the functionality to collect and preprocess data from the node cluster (100). In one or more embodiments, preprocessing the data includes encoding the data in a graph structure (i.e., the global graph (e.g., 200 in FIG. 2). In one or more embodiments, preprocessing the data includes extracting node information from the data to reveal nodes, edges, and node attributes (e.g., device type, device location, etc.). In one or more embodiments, the data management engine (104) includes the functionality to partition the global graph (e.g., 200 in FIG. 2) into subgraphs. In one or more embodiments, the data management engine (104) includes the functionality to determine edge weights (i.e., numerical values assigned to edges to quantify the strength, cost, and significance of the connections between nodes) and calculate diffusion scores (i.e., numerical values that represent the influence a node has on its respective subgraph) for nodes in each subgraph. Further, the data management engine (104) may include functionality to perform at least a portion of the methods shown in FIGS. 3-6. One of ordinary skill in the art will appreciate that the data management engine (104) may perform other functionalities without departing from the scope of the embodiments disclosed herein.

In one or more embodiments, the model generation engine (106) includes the functionality to generate a local graph neural network (GNN) model for each subgraph using edge weights, diffusion scores, and node attributes from each respective subgraph. In one or more embodiments, a GNN model refers a type of neural network (i.e., a system that learns patterns from training data by utilizing a number of layers, neurons (i.e., nodes), weights (i.e., parameters that are learned during training that determine the strength of connections between neurons in the neural network), biases (i.e., parameters learned during training that help neurons make decisions), activation functions, propagation functions, etc., which are generally used to model how the human brain processes information) designed to process and learn from data structured as graphs, where nodes represent IoT devices (e.g., nodes of the node cluster (100)) and edges represent connections between them. In one or more embodiments, the model generation engine (106) includes the functionality to generate a global GNN model using the parameters from the local GNN models. In one or more embodiments, the model generation employs sparse encoders to prune the global GNN model parameters to include information critical to the global GNN model when it is transmitted to devices. Further, the model generation engine (106) may include functionality to perform at least a portion of the methods shown in FIGS. 3-6. One of ordinary skill in the art will appreciate that the model generation engine (106) may perform other functionalities without departing from the scope of the embodiments disclosed herein.

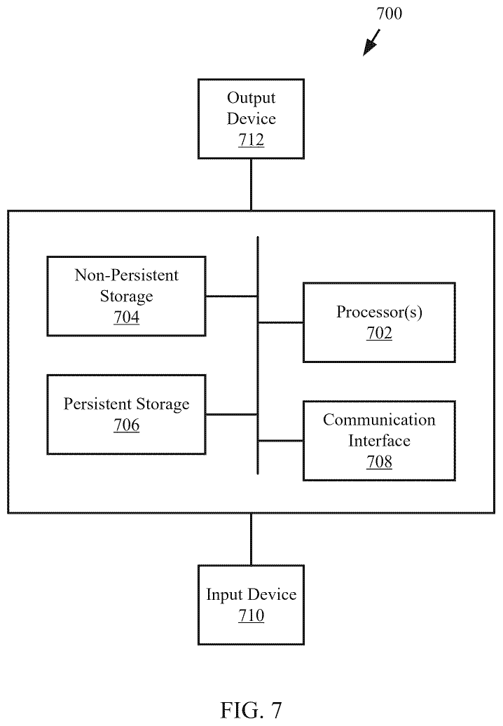

In one or more embodiments, the node cluster (100), the network (102), the data management engine (104), and the model generation engine (106) are each implemented as a computing device (e.g., 700, FIG. 7). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device cause the computing device to perform the functionality of the node cluster (100), the network (102), the data management engine (104), and the model generation engine (106) described throughout this application.

In one or more embodiments, the node cluster (100), the network (102), the data management engine (104), and the model generation engine (106) are each implemented as a logical device. The logical device may utilize the computing resources of any number of computing devices and thereby provide the functionality of the node cluster (100), the network (102), the data management engine (104), and the model generation engine (106).

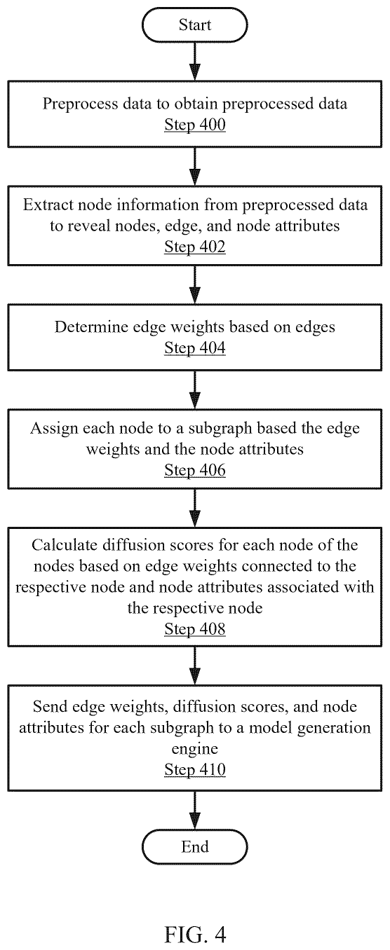

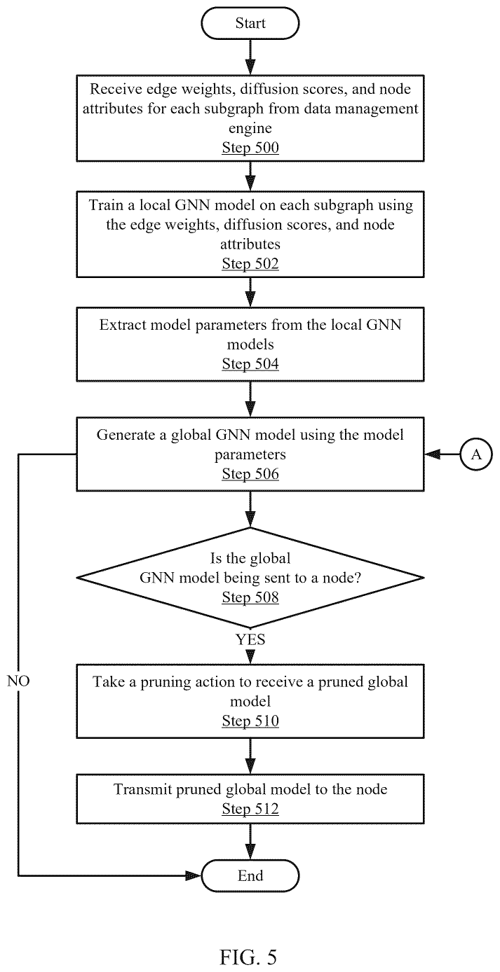

Turning to FIG. 2, FIG. 2 shows a diagram of a global graph (200) in accordance with one or more embodiments disclosed herein. In one or more embodiments, the global graph (200) is a graph-structured representation of nodes and edges within a node cluster (e.g., 100 in FIG. 1). In one or more embodiments, the global graph (200) includes A-N subgraphs and A-N local GNN models. In one or more embodiments, the A-N subgraphs each include A-N nodes. In one or more embodiments, A-N nodes represent IoT devices, including but not limited to sensors, actuators, etc. In one or more embodiments, the A-N nodes of each of the A-N subgraphs have connections (i.e., edges) between each other. In one or more embodiments, each of the A-N subgraphs is a partition of the global graph (200). In one or more embodiments, the global graph (200) is partitioned based on the similarity of the nodes in the global graph (200), as described in FIG. 4. In one or more embodiments, each of the A-N local GNN models is associated with each of the A-N subgraphs. In one or more embodiments, the A-N local GNN models are generated using node attitudes (i.e., device type, location within node cluster), edge weights (i.e., numerical values assigned to edges to quantify the strength, cost, and significance of the connections between nodes), and diffusion scores (i.e., numerical values that represent the influence a node has on its respective subgraph), as described in FIG. 5.

Turning to FIG. 3, FIG. 3 shows a flowchart of a method for generating data insights using a global graph neural network (GNN) model in accordance with one or more embodiments disclosed herein. The method may be performed by, for example, a data management engine (e.g., 104 in FIG. 1). Other components in the system may perform this method without departing from the scope of the disclosure.

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 3 may be performed concurrently with one or more steps in FIGS. 3-5.

In step 300, the data management engine collects data from a node cluster (e.g., 100 in FIG. 1). In one or more embodiments, the data is raw data from the nodes in the node cluster. In one or more embodiments, the nodes are IoT devices, including but not limited to sensors, actuators, etc. In one or more embodiments, the data includes sensor readings, actuator states, IoT device properties, etc.

In step 302, the data management engine prepares the data for a global GNN model as described in FIG. 4. In one or more embodiments, a GNN model refers a type of neural network (i.e., a system that learns patterns from training data by utilizing a number of layers, neurons (i.e., nodes), weights (i.e., parameters that are learned during training that determine the strength of connections between neurons in the neural network), biases (i.e., parameters learned during training that help neurons make decisions), activation functions, propagation functions, etc., which are generally used to model how the human brain processes information) designed to process and learn from data structured as graphs, where nodes represent IoT devices and edges represent connections between them. In one or more embodiments, preparing the data includes preprocessing the data, encoding the preprocessed data into a graph structure (i.e., the data represented as nodes and edges in graph form (i.e., global graph (e.g., 200 in FIG. 2)), partitioning the graph structure into subgraphs, extracting node attributes (e.g., device type, device location, etc.) from the preprocessed data, calculating edge weights (i.e., numerical values assigned to edges to quantify the strength, cost, and significance of the connections between nodes), and calculating diffusion scores (i.e., numerical values that represent the influence a node has on its respective subgraph) for the nodes in each subgraph as described in FIG. 4.

In step 304, the data management engine uses a model generation engine (e.g., 106 in FIG. 1) to generate the global GNN model, as described in FIG. 5. In one or more embodiments, generating the global GNN model includes training a local GNN model on each subgraph using the edge weights, diffusion scores, and node attributes, extracting model parameters from the local GNN models, and aggregating the local GNN model parameters to generate the global GNN model. It should be appreciated, that the model is representative of the global graph.

In step 306, the data management engine generates data insights using the global GNN model. In one or more embodiments, data insights include but are not limited to anomaly detection, optimization recommendations, predictive e maintenance identification, etc. In one or more embodiments, the data management engine generates data insights using the global GNN model by any means known in the art or discovered in the future. In one or more embodiments, the insights are presented to a user via a graphical user interface.

In step 308, the data management engine determines whether an action(s) is required based on the data insight. In one or more embodiments, the data management engine determines whether an action(s) is required by any means known in the art or discovered in the future. If the result is YES, then the method proceeds to step 310. If the result is no, then the method ends.

As a result of the data management engine determining that an action(s) is required, the method arrives at step 310. In step 310, the data management engine performs an action from an action set based upon the insight. In one or more embodiments, the actions from the action set include but are not limited to sending an alert to a user that includes an indication of the type of anomaly detected (e.g., sensor readings being incorrect, actuation state being incorrect, or any other type of fault associated with the device), taking a node of the node cluster offline, redistributing workloads amongst the nodes, adjusting a maintenance schedule for a node, and performing maintenance on a node of the node cluster.

In one or more embodiments, the method ends following step 310.

Turning to FIG. 4, FIG. 4 shows a flowchart of a method generating a global GNN model in accordance with one or more embodiments disclosed herein. The method may be performed by, for example, a data management engine (e.g., 104 in FIG. 1). Other components in the system may perform this method without departing from the scope of the disclosure.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 4 may be performed concurrently with one or more steps in FIGS. 3-5.

In step 400, the data management engine preprocesses data to obtain preprocessed data. In one or more embodiments, the data is data collected from a node cluster (e.g., 100 in FIG. 1), as described in FIG. 3. In one or more embodiments, the data is the same data as in FIG. 3. In one or more embodiments, the data is raw data from the nodes in the node cluster. In one or more embodiments, the nodes are IoT devices, including but not limited to sensors, actuators, etc. In one or more embodiments, the data includes sensor readings, actuator states, IoT device properties, etc. In one or more embodiments, preprocessing refers to normalizing numerical values in the data (e.g., sensor readings, signal strength, etc.), encoding categorical features of the data (e.g., device type, device location, etc.) into numerical form, and handling missing values in the data (e.g., use imputation for incomplete sensor readings). In one or more embodiments, the data management engine preprocesses the data by any means known to in the art or discovered in the future. In one or more embodiments, the preprocessed data in encoded into a graph structure (e.g., a global graph (e.g., 200 in FIG. 2)). In one or more embodiments, the global graph represents the data as nodes and edges (i.e., relationships between nodes, including but not limited to, signal strength, communication links, etc.), in a graph. In a non-limiting example, if the nodes are sensors, then the edges are communication links between the sensors defined by signal strength or proximity.

In step 402, the data management engine extracts node information from the preprocessed data to reveal nodes, edges, and node attributes (e.g., device type, device location, etc.). In one or more embodiments, the management engine extracts node information from the preprocessed data by any means known in the art or discovered in the future.

In step 404, the data management engine determines the edge weights of the edges. In one or more embodiments, edge weights refer to numerical values assigned to edges to quantify the strength, cost, and significance of the connections between nodes. In one or more embodiments, the data management engine determines the edge weights by any means known in the art or discovered in the future.

In step 406, the data management engine assigns each node to a subgraph based on the edge weights and the node attributes of each node. In one or more embodiments, nodes that have similar attributes and significant edge weights between them are assigned to the same subgraphs. In one or more embodiments, the data management engine assigns each node to a subgraph by any means known in the art or discovered in the future. In one or more embodiments, the subgraphs are partitions of the global graph. In one or more embodiments, the maximum size of each subgraph is defined based on the number of nodes and total edge weight between nodes. In one or more embodiments, the data management engine reassigns nodes and edges to different subgraphs to a balance distribution of nodes and edges. In one or more embodiments, the data management engine reassigns nodes to reduce the number of edges crossing between subgraphs. In a non-limiting example, node one may be in subgraph one and have a lot of edges with nodes in subgraph two, thus, the data management engine reassigns node one to subgraph two to eliminate the edges it had between the two subgraphs. In one or more embodiments, the data management engine monitors for changes in the global graph (e.g., new nodes or edges being added, nodes or edges being removed, etc.). In one or more embodiments, based on the monitoring, nodes and edges are reassigned to maintain balanced and efficient subgraphs. In one or more embodiments, the data management engine monitors for changes in the global graph by any means known in the art or discovered in the future.

In step 408, the data management engine calculates diffusion scores for each node based on edge weights connected to the respective node and node attributes associated with the respective node. In one or more embodiments, the diffusion scores refer to numerical values that represent the influence a node has on its respective subgraph. In one or more embodiments, the following function is used to calculate diffusion scores where wᵢⱼ is the weight of edge weight between node i and node j and f(j) is the node attribute value of node j.

$$Diffusion score of Node i = {\sum }_{j ∈ Neighbors ( i )} {w}_{ij} \cdot f ( j )$$

It should be appreciated, that the function above is a non-limiting example of a diffusion score function and that other functions based on edge weights and node attributes may be used to calculate the diffusion scores. In one or more embodiments, the diffusion scores are calculated by any means known in the art or discovered in the future. In one or more embodiments, the diffusion scores or normalized to ensure they are comparable across nodes. In one or more embodiments, the diffusion scores or normalized by any means known in the art or discovered in the future. In one or more embodiments, the data management engine updates the edge weights to reflect the nodes diffusion scores.

In step 410, the data management engine sends the edge weights, the diffusion scores, and node attributes for each node in the subgraphs to a model generation engine (e.g., 106 in FIG. 1). In one or more embodiments, data management engine sends the edge weights, the diffusion scores, and node attributes for each node in the subgraphs to the model generation engine by any means known in the art or discovered in the future.

In one or more embodiments, the method ends following step 410.

Turning to FIG. 5, FIG. 5 shows a flowchart of a method generating a global GNN model in accordance with one or more embodiments disclosed herein. The method may be performed by, for example, a model generation engine (e.g., 106 in FIG. 1). Other components in the system may perform this method without departing from the scope of the disclosure.

While the various steps in the flowchart shown in FIG. 5 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 5 may be performed concurrently with one or more steps in FIGS. 3-5.

In step 500, the model generation engine receives edge weights, diffusion scores, and node attributes for each node in subgraphs from a data management engine (e.g., 104 in FIG. 1). In one or more embodiments, the edge weights, the diffusion scores, the node attributes, and the subgraphs are the same edge weights, diffusion scores, node attributes, and subgraphs as in FIG. 4. In one or more embodiments, the subgraphs are partitions of a global graph (e.g., 200 in FIG. 2), as described in FIG. 4. In one or more embodiments, the global graph is the same global graph as in FIG. 4. In one or more embodiments, the global graph is a graph-structured data representation of a node cluster (e.g., 100 in FIG. 1). In one or more embodiments, node cluster is the same node cluster as in FIGS. 3-4.

In step 502, the model generation engine trains local graph neural network (GNN) models on each subgraph using the edge weights, diffusion scores, and node attributes to. In one or more embodiments, a GNN model refers a type of neural network (i.e., a system that learns patterns from training data by utilizing a number of layers, neurons (i.e., nodes), weights (i.e., parameters that are learned during training that determine the strength of connections between neurons in the neural network), biases (i.e., parameters learned during training that help neurons make decisions), activation functions, propagation functions, etc., which are generally used to model how the human brain processes information) designed to process and learn from data structured as graphs, where nodes represent IoT devices and edges represent connections between. In one or more embodiments, the local GNN models learn from and make predictions based on their relationships within the subgraphs, including the node attributes, the edge weights, and the diffusion scores. In one or more embodiments, the local GNN models are trained on each subgraph using the node attributes, the edge weights, and the diffusion scores from each subgraph. In one or more embodiments, the following loss function, commonly referred to as a mean-squared error or L2 loss function, is used to train the local GNN models where fi is the prediction for node i, and yi is the true label (i.e., actual value that is trying to be predicted).

$$ℒ = \frac{1}{N} {\sum }_{i = 1}^{N} {\vert {f}_{i} - {y}_{i} \vert}^{2}$$

It should be appreciated, that the function above is a non-limiting example of a loss function that may be used to train the local GNN models and that any loss function may be used to train the local GNN models, including L1, Huber, log, etc. In one or more embodiments, the model generation engine trains local GNN models on each subgraph using the edge weights and diffusion scores by any means known in the art or discovered in the future.

In step 504, the model generation engine extracts model parameters (e.g., weights and biases) from each of the local GNN models. In one or more embodiments, the model generation engine extracts model parameters from the local GNN models by any means known in the art or discovered in the future.

In step 506, the model generation engine generates a global GNN model using the local GNN model parameters. In one or more embodiments, the global GNN model is generated by aggregating all of the model parameters from the local GNN models. In one or more embodiments, the following weight-averaging function is used to generate the global GNN model where nᵢ is the number of nodes in subgraph i, wᵢ are the local GNN model parameters, and w_{global} are the global GNN model parameters.

$${W}_{global} = \frac{{\sum }_{i = 1}^{M} {n}_{i} \cdot {W}_{i}}{{\sum }_{i = 1}^{M} {n}_{i}}$$

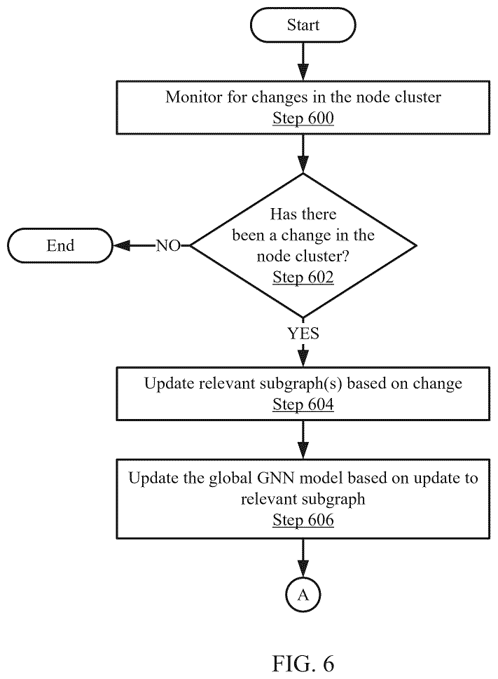

It should be appreciated, that the function above is a non-limited example of a weight-averaging function and that any function may be used to aggregate all the model parameters of the local GNN models. It should be appreciated, that the node cluster is constantly changing, as described in FIG. 6. In one or more embodiments, the model generation engine is constantly monitoring for such changes as described in FIG. 6. In one or embodiments, the model generation engine updates the global GNN model parameters based on the changes, as described in FIG. 6. In one or more embodiments, the model generation engine uses the updated global GNN model parameters to generate the global GNN model. It should be appreciated, that using the updated global GNN model parameters results in the most accurate global GNN model. In one or more embodiments, the model generation engine generates a global GNN model by any means known in the art or discovered in the future.

In step 508, the model generation engine determines whether the global GNN model is being sent to a node to be deployed. In one or more embodiments, the model generation engine makes the determination by any means known in the art or discovered in the future. If the result is YES, then the method proceeds to step 510. If the result is NO, then the method ends.

As a result of the model generation engine determining that the global GNN model is being sent to a node, the method arrives at step 510. In step 510, the model generation engine takes a pruning action to receive a pruned global GNN model. In one or more embodiments, the pruning action includes implementing sparse encoders. In one or more embodiments, the sparse encoders are implemented by identifying critical parameters within the global GNN model through threshold-based pruning, which removes parameters with magnitudes below a threshold. In one or more embodiments, the threshold is determined by any means known in the art or discovered in the future. It should be appreciated, that the threshold-based pruning removes parameters with small magnitudes, which are less important to the global GNN model's output. In a non-limiting example, parameters [0.8, 0.5, 0.3, 0.1] are pruned to [0.8, 0.5]. In one or more embodiments, indices and values of critical parameters (i.e., parameters that didn't get pruned) are stored. It should be appreciated, that sparse encoders are used to optimize the communication of the global GNN model parameters across nodes by compressing the global GNN model parameters to retain the most critical information, thereby minimizing communication overhead while maintaining global GNN model accuracy.

In step 512, the model generation engine transmits the pruned global GNN model to the node. In one or more embodiments, the model generation engine transmits the pruned global GNN model to the node by any means known in the art or discovered in the future. In one or more embodiments, transmitting the pruned global GNN model includes sending the pruned global GNN model parameters.

In one or more embodiments, the method ends following step 512.

Turning to FIG. 6, FIG. 6 shows a flowchart of a method for monitoring a node cluster in accordance with one or more embodiments disclosed herein. The method may be performed by, for example, a data management engine (e.g., 104 in FIG. 1). Other components in the system may perform this method without departing from the scope of the disclosure.

While the various steps in the flowchart shown in FIG. 6 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 6 may be performed concurrently with one or more steps in FIGS. 3-5.

In step 600, the data management engine monitors for changes in a node cluster (e.g., 100 in FIG. 2). In one or more embodiments, the node cluster is the same node cluster as in FIGS. 3-4. In one or more embodiments, changes in the node cluster may include but are not limited to nodes or edges being added to the node cluster, nodes or edges being removed from the node cluster, nodes or edges failing, nodes or edges receiving updates, etc. In one or more embodiments, the data management engine monitors for changes in the node cluster by any means known in the art or discovered in the future.

In step 602, the data management engine determines whether there have been any changes in the node cluster. In one or more embodiments, the data management engine makes the determination by any means known in the art or discovered in the future. If the result is YES, the method proceeds to step 604. If the result is NO, then the method ends.

As a result of the data management engine determining that there have been changes in the node cluster, the method arrives at step 604. In step 604, the data management engine updates relevant subgraphs (i.e., partitions of a global GNN model (e.g., 200 in FIG. 2) (i.e., a graphical representation of the node cluster)) based on the changes. In one or more embodiments, the global graph and the subgraphs are the same global graph and subgraphs as in FIG. 4. In one or more embodiments, updating the relevant subgraphs includes but is not limited to adding nodes to the relevant subgraphs to represent nodes that have been added to the node cluster, removing nodes from the relevant subgraphs to represent nodes that have been removed from the node cluster, and updating edge weights within the relevant subgraphs based on the changes.

In step 606, the data management engine updates a global GNN model based on the update(s) to the relevant subgraph(s) to obtain an updated global GNN model. In one or more embodiments, the global GNN model is the same global GNN model as in FIG. 5. In one or more embodiments, updating the global GNN model includes updating the parameters of the global GNN model based on the updates to the subgraphs. In one or more embodiments, incremental learning techniques are applied to avoid retraining the entire global GNN model when updating the global GNN model. In one or more embodiments, the data management engine applies temporal smoothing techniques (i.e., time series analysis methods that help maintain stable predictions over time by reducing fluctuations) to the updated global GNN model parameters. It should be appreciated, that the temporal smoothing techniques are used to maintain constant and stable predictions over time by the global GNN model. In one or more embodiments, the data management engine updates the global GNN model by any means known in the art or discovered in the future.

Following step 606, the method proceeds to step 508 in FIG. 5.

Embodiments of the disclosure may be implemented using computing devices. Turning to FIG. 7, FIG. 7 shows a diagram of a computing device (700) in accordance with one or more embodiments. The computing device (700) may include one or more computer processor(s) (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (708) (e.g., Bluetooth interface, infrared interface, network interface, optical interface, etc.), input devices (710), output devices (712), and numerous other elements (not shown) and functionalities. Each of these components is described below.

In one embodiment, the computer processor(s) (702) may be an integrated circuit for processing instructions. For example, the computer processor(s) (702) may be one or more cores or micro-cores of a processor. The computing device (700) may also include one or more input devices (710), such as a touchscreen, access keyboard, mouse, microphone, touchpad, electronic pen, or any other type of input device. The communication interface (708) may include an integrated circuit for connecting the computing device (700) to a network (e.g., 102 in FIG. 1) (e.g., a local area network (LAN), a wide area network (WAN) such as the Internet, mobile network, or any other type of network) and/or to another device, such as another computing device.

In one embodiment, the computing device (700) may include one or more output devices (712), such as a screen (e.g., a liquid crystal display (LCD), a plasma display, touchscreen, cathode ray tube (CRT) monitor, projector, or other display device), a printer, external storage, or any other output device. One or more of the output devices (712) may be the same or different from the input devices (710). The input and output device(s) (710, 712) may be locally or remotely connected to the computer processor(s) (702), non-persistent storage (704), and persistent storage (706). Many diverse types of computing devices exist, and the aforementioned input and output device(s) (710, 712) may take other forms.

The problems discussed above should be understood as being examples of problems solved by embodiments of the disclosure, and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connection between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage module, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A method for generating a global graph neural network (GNN) model, the method comprising:
collecting data from a node cluster;
preparing the data for the global GNN model, wherein the preparing comprises:
preprocessing the data to obtain preprocessed data;
extracting node information from the preprocessed data to obtain nodes, edges, and node attributes;
determining edge weights based on the edges;
assigning each node to a subgraph based on the edge weights and the node attributes; and
calculating, based on the assigning, diffusion scores for each node of the nodes based on the edge weights connecting the nodes and the node attributes associated with the nodes within respective subgraphs; and
generating the global GNN model using the edge weights, the diffusion scores, and the node attributes from each subgraph.

2. The method of claim 1, further comprising:
generating a data insight using the global GNN model; and
performing an action from an action set based upon the data insight.

3. The method of claim 2, wherein actions from the action set include at least one of sending an alert to a user, taking a node of the nodes offline, and performing maintenance on a node of the nodes.

4. The method of claim 1, wherein generating the global GNN model comprises:
training local GNN models on each of the subgraphs using the edge weights, the diffusion scores, and the node attributes of the nodes in the respective subgraphs;
extracting model parameters from the local GNN models; and
generating the global GNN model using the model parameters.

5. The method of claim 1, further comprising:
making a second determination, after the generating, to transmit the global GNN model to a node of the nodes;
taking, based on the second determination, a pruning action to receive a pruned global GNN model; and
transmitting the pruned global GNN model to the node of the nodes.

6. The method of claim 5, wherein the pruning action includes implementing sparse encoders by removing model parameters of the global GNN model with magnitudes below a threshold.

7. The method of claim 1, further comprising:
monitoring, after the generation, for changes in the node cluster;
making a third determination, based on the monitoring, that there has been a change in the node cluster;
updating, in response to the third determination, a relevant subgraph based on the changes; and
updating, the model based on the update to the relevant subgraph.

8. The method of claim 7, wherein updating the relevant subgraph may include at least one of:
removing a node from the relevant subgraph, adding a node to the relevant subgraph, and moving a node to another subgraph.

9. The method of claim 7, wherein the changes include at least one of: a node being added to the node cluster, a node being removed from the node cluster, a node failing in the node cluster, and a node updating in the node cluster.

10. A non-transitory computer readable medium (CRM) comprising computer readable program code, which when executed by a computer processor, enables the computer to perform a method for generating a global graph neural network (GNN) model, the method comprising:
collecting data from a node cluster;
preparing the data for the global GNN model, wherein the preparing comprises:
preprocessing the data to obtain preprocessed data;
extracting node information from the preprocessed data to obtain nodes, edges, and node attributes;
determining edge weights based on the edges;
assigning each node to a subgraph based on the edge weights and the node attributes; and
calculating, based on the assigning, diffusion scores for each node of the nodes based on the edge weights connecting the nodes and the node attributes associated with the nodes within respective subgraphs; and
generating the global GNN model using the edge weights, the diffusion scores, and the node attributes from each subgraph.

11. The non-transitory CRM of claim 10, further comprising:
generating a data insight using the global GNN model; and
performing an action from an action set based upon the data insight.

12. The non-transitory CRM of claim 11, wherein actions from the action set include at least one of sending an alert to a user, taking a node of the nodes offline, and performing maintenance on a node of the nodes.

13. The non-transitory CRM of claim 10, wherein generating the global GNN model comprises:
training local GNN models on each of the subgraphs using the edge weights, the diffusion scores, and the node attributes of the nodes in the respective subgraphs;
extracting model parameters from the local GNN models; and
generating the global GNN model using the model parameters.

14. The non-transitory CRM of claim 10, further comprising:
making a second determination, after the generating, to transmit the global GNN model to a node of the nodes;
taking, based on the second determination, a pruning action to receive a pruned global GNN model; and
transmitting the pruned global GNN model to the node of the nodes.

15. The non-transitory CRM of claim 14, wherein the pruning action includes implementing sparse encoders by removing model parameters of the global GNN model with magnitudes below a threshold.

16. The non-transitory CRM of claim 10, further comprising:
monitoring, after the generation, for changes in the node cluster;
making a third determination, based on the monitoring, that there has been a change in the node cluster;
updating, in response to the third determination, a relevant subgraph based on the changes; and
updating, the model based on the update to the relevant subgraph.

17. A system for generating a global graph neural network (GNN) model, the system comprising:
persistent storage; and
a computing device, comprising a processor and memory, programmed to:
collect data from a node cluster;
prepare the data for the global GNN model, wherein the preparing comprises:
preprocess the data to obtain preprocessed data;
extract node information from the preprocessed data to obtain nodes, edges, and node attributes;
determine edge weights based on the edges;
assign each node to a subgraph based on the edge weights and the node attributes; and
calculate, based on the assigning, diffusion scores for each node of the nodes based on the edge weights connecting the nodes and the node attributes associated with the nodes within respective subgraphs; and
generate the global GNN model using the edge weights, the diffusion scores, and the node attributes from each subgraph.

18. The system of claim 17, wherein the computing device is further programmed to:
generate a data insight using the global GNN model; and
perform an action from an action set based upon the data insight.

19. The system of claim 17, wherein generating the global GNN model comprises:
training local GNN models on each of the subgraphs using the edge weights, the diffusion scores, and the node attributes of the nodes in the respective subgraphs;
extracting model parameters from the local GNN models; and
generating the global GNN model using the model parameters.

20. The system of claim 17, wherein the computing device is further programmed to:
make a second determination, after the generating, to transmit the global GNN model to a node of the nodes;
take, based on the second determination, a pruning action to receive a pruned global GNN model; and
transmit the pruned global GNN model to the node of the nodes.
